(19) United States
(12) Patent Application Publication
(10) Pub. No.: US 2026/0137493 A1
(43) Pub. Date: May 21, 2026

(54) SYSTEMS AND METHODS FOR DENTURE INJECTION MOLD DESIGN AND MANUFACTURE

(71) Applicant: Zima International, Inc. d/b/a Dandy, New York, NY (US)

(72) Inventors: Patrick R. Moore, New York, NY (US); Kenn Butler, New York, NY (US); Samuel Wainwright, New York, NY (US)

(21) Appl. No.: 19/327,876

(22) Filed: Sep. 12, 2025

Related U.S. Application Data
(60) Provisional application No. 63/694,719, filed on Sep. 13, 2024.

(51) Int. Cl. A61C 13/20; A61C 13/00

(52) U.S. Cl. CPC A61C 13/206; A61C 13/0004

(57) ABSTRACT

The present disclosure provides a method for generating a dental appliance injection model. The method comprises receiving a three-dimensional (3D) dental model representing a dental appliance, detecting a parting direction of a mold of the dental model, generating a parting line around a perimeter of the 3D dental model using a first executable algorithm, generating a parting surface for the dental model using a second executable algorithm, and generating a first digital representation of a first mold component and a second digital representation of a second mold component aligned with the parting line, wherein the first mold component and the second mold component define a mold cavity.

### CROSS-REFERENCE TO RELATED APPLICATIONS

This application claims priority to provisional U.S. Application No. 63/694,719, titled “Design Software for Modeling Denture Injection Molds,” filed Sep. 13, 2024, which is hereby incorporated by reference in its entirety.

### FIELD OF INVENTION

The present disclosure generally relates to the creation of molds for injection molding, and to the manufacture of dental appliances and dental prostheses.

### BACKGROUND

The design and manufacture of dental prosthetics, such as dentures and partial dentures, presents numerous technical challenges that have traditionally relied on manual processes and conventional design approaches. Dental prosthetics are highly customized medical devices that must precisely match each patient's unique oral anatomy, including the specific contours of their teeth, gums, and supporting structures. The manufacturing process often involves injection molding techniques, where molten materials such as acrylic resins are injected into carefully designed molds to form the final prosthetic devices. However, the complex three-dimensional geometry of dental structures creates substantial difficulties in mold design, particularly when attempting to create molds that can be successfully separated after the molding process is complete.

Existing computer-aided design software tools, while useful for general three-dimensional modeling applications, lack specialized functionality for addressing the unique challenges associated with dental prosthetic mold design. These conventional CAD systems typically do not provide automated methods for identifying optimal parting lines, generating appropriate parting surfaces, or detecting problematic undercut areas that can prevent proper ejection of molded parts. The complex curved surfaces and intricate geometries inherent in dental anatomy often result in undercuts that interfere with the injection molding process, making it difficult or impossible to remove the finished prosthetic from the mold without damage.

Furthermore, the need to accommodate material flow considerations, air evacuation pathways, and proper mold separation mechanisms while maintaining the precise dimensional accuracy demanded by dental applications creates additional design challenges that are not adequately addressed by conventional CAD platforms.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for generating a dental appliance injection model is provided. The method comprises receiving a three-dimensional (3D) dental model representing a dental appliance. The method comprises detecting a parting direction of a mold of the dental model. The method comprises generating a parting line around a perimeter of the 3D dental model at least in part by detecting one or more of occlusal and gingival surfaces, gumline boundaries, and arch curvature using a first executable algorithm. The method comprises generating a parting surface for the dental model using a second executable algorithm. The method comprises generating a first digital representation of a first mold component and a second digital representation of a second mold component and is aligned with the parting line. The first mold component and the second mold component define a mold cavity.

According to other aspects of the present disclosure, the method may include one or more of the following features. The method may further comprise generating a slide component for insertion into at least one of the first mold component or the second mold component to change a shape of the mold cavity. Generating the slide component may comprise detecting in either of the first mold component or the second mold component, an undercut area. Generating the slide component may comprise generating the slide component to form at least a portion of a shape of the undercut area within the mold cavity. The method may further comprise generating at least one sprue within at least one of the first mold component or the second mold component, wherein each of the at least one sprue intersects the parting surface and the mold cavity. Generating the at least one sprue may comprise generating a channel extending from the mold cavity to an exterior surface of the first mold component or the second mold component. The at least one sprue may extend between a mold cavity and a pour port location at the exterior surface of the first mold component or the second mold component. The at least one sprue may comprise a main trunk channel and a plurality of branch channels extending from the main trunk channel to different locations on the mold cavity. Generating the at least one sprue may comprise automatically selecting locations on an edge of the dental model that intersect the parting surface for connecting the at least one sprue with the mold cavity.

According to another aspect of the present disclosure, a system for generating a dental appliance injection model is provided. The system comprises a processor. The system comprises a memory storing instructions that, when executed by the processor, cause the processor to receive a three-dimensional (3D) dental model representing a dental appliance. The instructions cause the processor to detect a parting direction of a mold of the dental model. The instructions cause the processor to generate a parting line around a perimeter of the 3D dental model at least in part by detecting one or more of occlusal and gingival surfaces, gumline boundaries, and arch curvature using a first executable algorithm. The instructions cause the processor to generate a parting surface for the dental model using a second executable algorithm. The instructions cause the processor to generate a first digital representation of a first mold component and a second digital representation of a second mold component and is aligned with the parting line. The first mold component and the second mold component define a mold cavity.

According to other aspects of the present disclosure, the system may include one or more of the following features. The instructions may further cause the processor to generate a slide component for insertion into at least one of the first mold component or the second mold component to change a shape of the mold cavity. Generating the slide component may comprise detecting in either of the first mold component or the second mold component, an undercut area. Generating the slide component may comprise generating the slide component to form at least a portion of a shape of the undercut area within the mold cavity. The instructions may further cause the processor to generate at least one sprue within at least one of the first mold component or the second mold component, wherein each of the at least one sprue intersects the parting surface and the mold cavity. Generating the at least one sprue may comprise generating a channel extending from the mold cavity to an exterior surface of the first mold component or the second mold component. The at least one sprue may extend between a mold cavity and a pour port location at the exterior surface of the first mold component or the second mold component. The at least one sprue may comprise a main trunk channel and a plurality of branch channels extending from the main trunk channel to different locations on the mold cavity. Generating the at least one sprue may comprise automatically selecting locations on an edge of the dental model that intersect the parting surface for connecting the at least one sprue with the mold cavity.

According to another aspect of the present disclosure, a non-transitory computer-readable medium storing instructions that, when executed by a processor, cause the processor to perform a method for generating a dental appliance injection model is provided. The method comprises receiving a three-dimensional (3D) dental model representing a dental appliance. The method comprises detecting a parting direction of a mold of the dental model. The method comprises generating a parting line around a perimeter of the 3D dental model at least in part by detecting one or more of occlusal and gingival surfaces, gumline boundaries, and arch curvature using a first executable algorithm. The method comprises generating a parting surface for the dental model using a second executable algorithm. The method comprises generating a first digital representation of a first mold component and a second digital representation of a second mold component and is aligned with the parting line. The first mold component and the second mold component define a mold cavity.

According to other aspects of the present disclosure, the non-transitory computer-readable medium may include one or more of the following features. The method may further comprise generating a slide component for insertion into at least one of the first mold component or the second mold component to change a shape of the mold cavity. Generating the slide component may comprise detecting in either of the first mold component or the second mold component, an undercut area. Generating the slide component may comprise generating the slide component to form at least a portion of a shape of the undercut area within the mold cavity. The method may further comprise generating at least one sprue within at least one of the first mold component or the second mold component, wherein each of the at least one sprue intersects the parting surface and the mold cavity. Generating the at least one sprue may comprise generating a channel extending from the mold cavity to an exterior surface of the first mold component or the second mold component. The at least one sprue may extend between a mold cavity and a pour port location at the exterior surface of the first mold component or the second mold component. The at least one sprue may comprise a main trunk channel and a plurality of branch channels extending from the main trunk channel to different locations on the mold cavity. Generating the at least one sprue may comprise automatically selecting locations on an edge of the dental model that intersect the parting surface for connecting the at least one sprue with the mold cavity.

The foregoing general description of the illustrative embodiments and the following detailed description thereof are merely exemplary aspects of the teachings of this disclosure and are not restrictive.

### BRIEF DESCRIPTION OF FIGURES Non-limiting and non-exhaustive examples are described with reference to the following figures.

FIG. 1 is a block diagram illustrating an example system for modeling injection molds for the manufacture of dental articles.

FIG. 2 is a flow chart illustrating an example method of preparing a model for an injection mold for the manufacture of dental articles.

FIG. 3 is a flow chart illustrating an example method of generating a parting line for a dental injection mold.

FIG. 4 is a flow chart illustrating an example method of generating a parting surface for a dental injection mold.

FIG. 5 is a flow chart illustrating an example method of identifying undercut areas in the design of a dental injection mold.

FIG. 6 is a flow chart illustrating an example method of generating a dental injection mold.

FIG. 7 is a flow chart illustrating an example method of generating slides for undercut areas for a dental injection mold.

FIG. 8 is a diagrammatic view of an example user computing environment.

FIG. 9 is a front perspective view of an example dental model.

FIG. 10 is a top view of the dental model of FIG. 9.

FIG. 11 is a side elevation view of the dental model of FIG. 9.

FIG. 12 is a side perspective view of the dental model of FIG. 9.

FIG. 13A and FIG. 13B are top and bottom plan views of the dental model of FIG. 9, respectively.

FIG. 14A and FIG. 14B are front and side perspective views of the dental model of FIG. 9, respectively.

FIG. 15 is a rear perspective view of the dental model of FIG. 9 inside an example mold-blank geometry.

FIG. 16 is a detail view of the dental model of FIG. 9.

FIG. 17 is a top perspective view of the dental model of FIG. 9 with example proposed mold slide geometry.

FIG. 18 is a top plan view of a first injection mold part and a second injection mold part for the example dental model of FIG. 9.

FIG. 19A and FIG. 19B are detail views of the example dental model of FIG. 9, respectively.

FIG. 20A and FIG. 20B are detail views of the example dental model of FIG. 9, respectively.

FIG. 21 is a flowchart illustrating an example method of generating a mold with sprues therein.

FIG. 22 is an example view of a user interface for locating sprues within a mold.

FIG. 23A and FIG. 23B are perspective views of sprues modeled within a mold.

FIG. 24A and FIG. 24B are perspective view of a mold in disassembled and assembled configurations.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure describes systems and methods for designing a mold and/or mold components for the manufacturing of dental prostheses or dental appliances, such as partial dentures or full dentures. In some embodiments the injection molds may be configured to support pre-manufactured prosthetic teeth within a cavity of the mold, while other portions of the cavity are to be filled with a molding material (e.g., an acrylic) that cures within the mold and around bases of the prosthetic teeth to form prosthetic gums. In other embodiments, the teeth are formed from injection molding (such that material is injected into the molds described herein for forming the teeth) and/or the teeth and gums are both formed from injection molding within the cavity of the described molds. Specifically, the systems and methods disclosed may be used in designing injection molds for the manufacture of dentures and other dental prostheses, dental replacements, or dental appliances. Injection molding and even casting dental prostheses and appliances presents a challenge, as each patient's teeth profile varies from one another, and thus one dental mold for the creation of dental appliances for one patient likely will not be the same as the mold for another patient. Further, the orientation of a patient's teeth, gums, and bone structure may be such that, in designing a mold for the creation of a dental prosthesis, an undercut may occur in the mold design.

Undercuts in mold designs, specifically injection mold designs, are generally disfavored. This is due to the constraints and limitations of injection molding. Generally, in injection molding, two complimentary halves contain a hollowed-out chamber which together form one whole part or product design. The two halves are separated at a parting line. During injection molding, the halves are held together at the parting line, and material is “injected” into the mold. After, the two halves of the mold are separated, revealing the shape of the final product. The part is removed from the halves by a part ejection process.

An undercut in an injection mold is anywhere that the material to be injected into the mold would wrap around the mold in an orientation that would prevent the final product from being ejected from the injection mold. If either half of the injection mold contains an undercut, the final injection molded part or product would be unable to released from the mold. Therefore, it is critical that injection molds, and specifically injection molds for dental prostheses, contain as few undercut regions as possible and minimize the severity of undercut regions while maintaining the physical design requirements of the dental prosthesis or appliance.

Injection molds may generally be modeled in 3D CAD software. However, even with the assistance of CAD software, modeling injection molds and especially molds for dental appliances and prostheses, which contain complex geometry, is a difficult process. The present disclosure offers systems and methods that may greatly improve the efficiency in modeling injection molds for dental parts. Specifically, various embodiments may improve the efficiency by accomplishing one or more of: improving the importing of a patient's dental model or model of a dental appliance or prosthesis into 3D CAD software; identifying a parting line for a mold of the dental appliance or prosthesis or of the patient's dental model; creating a parting surface for two complimentary mold halves based off the identified parting line and which bisects the patient's dental model or model of a dental appliance; identifying potential undercuts in a dental mold based on the patient's dental model; creating a proposed mold geometry by subtracting the patient's dental model from a block of material through a Boolean operation, and providing slide geometry in the proposed mold geometry based on the identified potential undercuts.

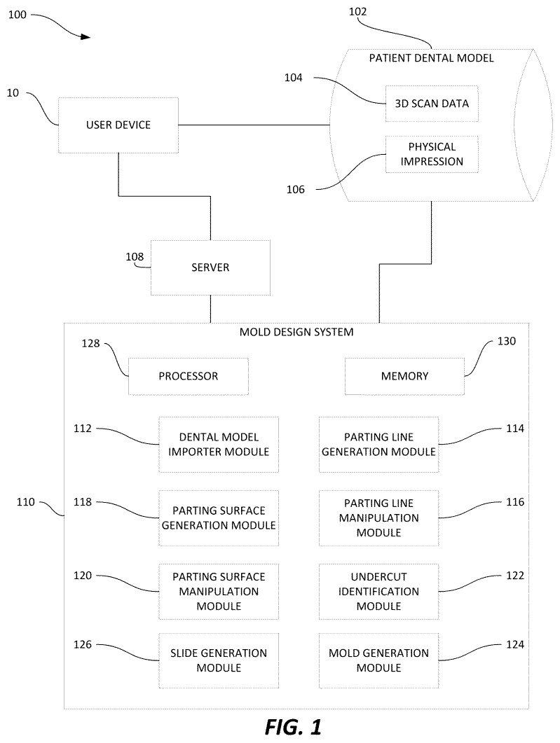

Referring now to the drawings, wherein like numerals refer to the same or similar features in the various views, FIG. 1 is a diagrammatic view of an example system 100 for designing injection molds for the manufacture of dental appliances and prostheses, in accordance with various embodiments. The system 100 may include a patient's dental model 102 which may further include one or more of 3D scan model data 104 or a physical impression 106. In some embodiments, the patient's dental model 102 may be a 3D scan of a patient's mouth or oral cavity, and the injection mold designed by the current disclosure may be one which creates a 3D representation of a patient's current dentition. In some embodiments, the patient's dental model 102 may be a dental model of a proposed dental article or dental prosthesis, such as a denture, and the injection mold designed by the current disclosure may be one which creates the dental article or dental prosthesis, such as a denture. It shall be known that when referring to a “dental model” or a “patient's dental model” that reference may either be made to any of a 3D representation of a patient's current dentition or a 3D model of a proposed dental article or dental prosthesis, such as a denture.

The system may further include a server 108. The system 100 may further include a mold design system 110. The mold design system 110 may further include functional modules, including a dental model importer module 112 (e.g., configured to receive intraoral scan data or digitized impressions with metadata identifying and/or differentiating between occlusal and gingival surfaces), a parting line generation module 114 (e.g., optimized for dental arch curvature), a parting line manipulation module 116, a parting surface generation module 118 (e.g., that aligns parting lines with gumline topology within a dental model), a parting surface manipulation module 120, an undercut identification module 122 (e.g., that detects interproximal and palatal undercuts unique to denture designs), a mold generation module 124 (e.g., configured for over-molding pre-fabricated denture teeth), and a slide generation module 126 (e.g., for generating slides aligned to dental anatomy vectors for retrievability of acrylic dentures after acrylic resin has cured). In some embodiments, the functional modules 112, 114, 116, 118, 120, 122, 124, and 126 of the mold design system 110 may be embodied in a processor 128 and a memory 130 (i.e., a non-transitory, computer-readable medium) storing instructions that, when executed by the processor 128, cause the processor 128 to perform the functionality of one or more of the functional modules and/or other functionality of this disclosure.

Various embodiments include modules and processes which may design injection molds for dental appliances and prostheses without undercuts. The disclosed mold design system 110 and method include obtaining a dental impression or 3D scan of a patient and using a dental model importer module 112 to upload that impression or 3D model into a computer-aided design (“CAD”) platform or mold design system 110 to produce a dental model for the patient. The mold design system 110 and method may also include using an executable algorithm within a parting line generation module 114 to identify the maximum-width points along the dental arc of the patient's dental model and generate an initial parting line for a mold along the dental arc of the patient's dental model. The mold design system 110 may further include a parting line manipulation module 116 for modifying the proposed parting line from the parting line generation module 114. The mold design system 110 may further include using a second executable algorithm within a parting surface generation module 118 which generates a parting surface according to the parting line and which passes entirely through the patient's dental model, creating a parting surface for an injection mold. The parting surface generation module 118 of certain embodiments is configured to generate a parting surface that bisects the dental arch reflected in the dental model and conforms to the gumline geometry of the dental model in a way that minimize undercuts for the resulting mold. The system 110 may further include a parting surface manipulation module 120 for modifying the parting surface (e.g., enabling manual modification of the geometry and/or location of portion(s) or all of the parting surface).

The mold design system 110 may also include an undercut identification module 122 which may identify possible undercuts in a resulting injection mold based off the geometry of the patient's dental model and the proposed parting surface or parting surface for the dental mold. The system 110 may also include a mold generation module 124 for creating an injection mold of the patient's dental model by removing the imported 3D scan of a dental appliance, dental article, or a patient's dental profile from a solid block of material in CAD through, for example, a Boolean operation such as subtraction, mesh extraction, volumetric for field-based Boolean operations, and further separating the solid block of material into two halves to create a first and second side of an injection mold.

Finally, the system and method may further include a slide generation module 126 for selecting areas on the patient's dental model for which to provide a slide insert for the generated mold, based off the undercut areas identified by the undercut identification module 122, and to allow for a proposed injection mold for a dental appliance to properly eject an injection molded part, or to facilitate insertion of premade parts for overmolding. A slide may be an insertable or removable segment of the mold body which may allow for installation of prefabricated parts into the mold before injection and/or may improve the retrievability or removability of the final dental article from the mold after injection. The slide generation module 126 may further segment or separate the respective mold halves into separate slides, based on the slide areas identified by the undercut identification module 126.

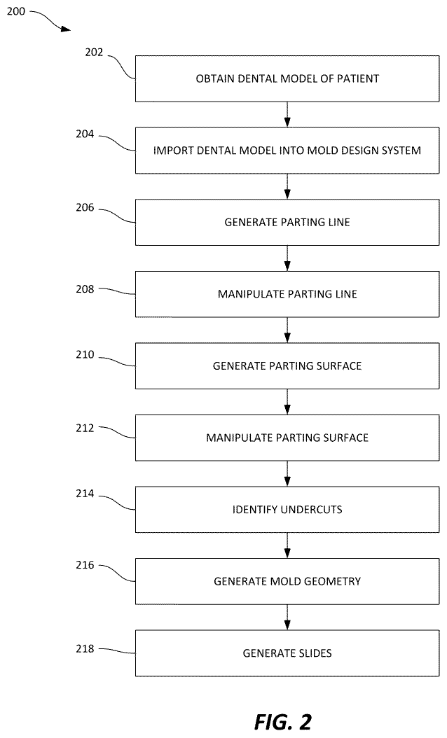

FIG. 2 is a flow chart illustrating an example method 200 of designing an injection mold for a dental appliance or prosthesis, in accordance with various embodiments. The method 200, or one or more portions of the method 200, may be performed by the system 100, and more particularly by the mold design system 110, in some embodiments. The method 200 may include at block 202 obtaining, by a user, data representative of the dental model of a patient.

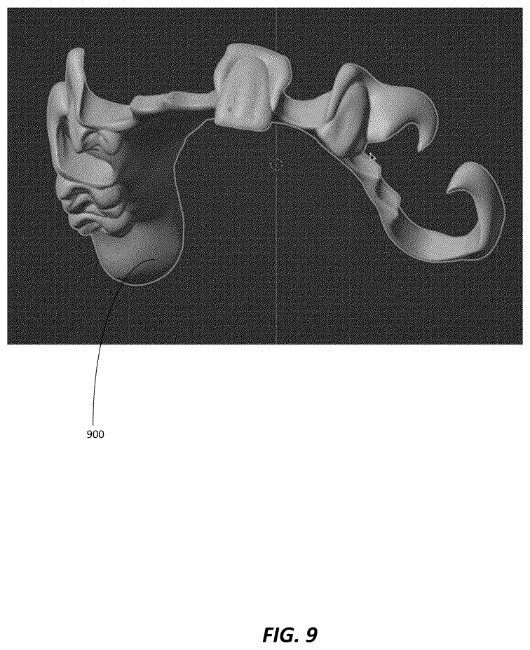

FIG. 9 is an example of data representative of the dental model of a patient 900. In some examples, such as the example data representative of the dental model of a patient 900 illustrated in FIG. 9, the patient's dental model may be a dental appliance or dental prosthesis, such as a denture (full denture or partial denture), that is modeled using 3D CAD software. In an example, the dental model of a patient 900 may be a dental appliance or prosthesis that is modeled in 3D CAD software and based on a 3D scan of the patient's oral cavity. In an example, the dental model of a patient 900 may be a dental appliance or prosthesis that is modeled in 3D CAD software and based on a prescribed or desired position and arrangement of the patient's dentition. In an example, the dental model of a patient 900 may be a dental appliance or prosthesis that is modeled in 3D CAD software and based on either or both of a 3D scan of the patient's oral cavity and a prescribed or desired arrangement of the patient's dentition.

In some examples, a patient's dental model 900 may be a 3D model of the patient's current dentition obtained by a 3D scanning device which may scan the patient's mouth and/or dental cavity. A resulting 3D scan of a patient's mouth and/or dental cavity may contain geometry of the patient's teeth, gums, hard tissues, and soft tissues, stored in a computer-readable medium. In another example, a physical impression of the patient's mouth and/or dental cavity may be taken using a physical mold filled with a mold compound, putty, elastomer, or similar material. A scan may then be taken of the physical dental impression, the scan containing geometry of the inverse, or “negative” of the geometry of the patient's teeth, gums, hard tissues, and soft tissues, stored in a computer-readable medium. The inverse or “negative” geometry is a negative imprint of hard and soft tissues in the mouth from which a positive reproduction, such as a cast or model, can be formed. In other examples, data representative of the dental model of a patient may be obtained in other ways, such as using a scanning probe, coordinate-measuring machine (CMM), or similar device, to collect data points from the patient's mouth directly or from a dental impression taken from the patient, and which achieves the same result.

Returning to FIG. 2, the method 200 may further include, at block 204, importing the dental model of a patient into a mold design system. In an example, a mold design system, and specifically a dental model importer module (such as the dental model importer module 112 pictured in FIG. 1) may receive from a user or from a server, data respective of a dental model of a patient. In some examples, the data respective of a dental model (such as the data respective of a dental model 900 illustrated in FIG. 9) may be the 3D scan information from a scan taken of the mouth of a patient. The dental model importer module may convert the data respective of a patient's dental model into a 3D model in a computing language compatible with the computing language of a mold design system (such as the mold design system 110 in FIG. 1). In another example, the data respective of a dental model may be the inverse or negative of the patient's dental model obtained from a physical impression. In the example, the dental model importer module may convert the inverse or negative data respective of a patient's dental impression into a model of the patient's actual or “positive” dental model. The dental model importer module may then convert the data respective of a patient's dental model into a 3D model in a computing language compatible with the computing language of a mold design system.

The method 200 may further include, at block 206, generating a parting line on the dental model. The parting line may be a parting line configured to separate a patient's dental model into two halves which may be optimized for injection molding.

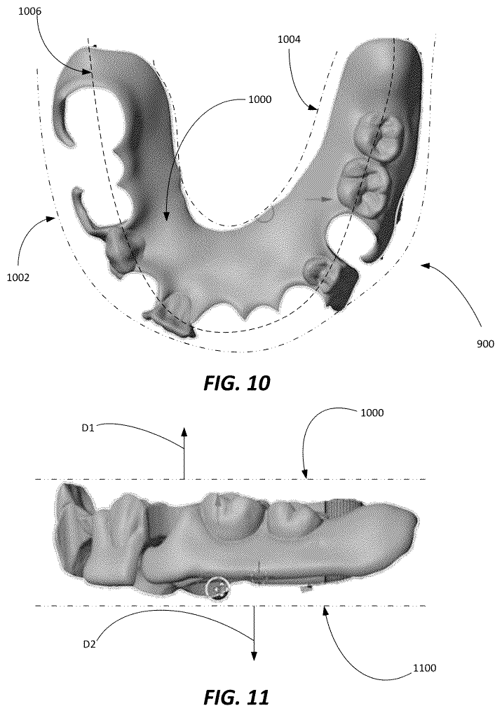

FIGS. 10 and 11 illustrate top and side views, respectively, of the example data of a dental model 900 of FIG. 9. In an example, a patient's dental model 900 may be positioned in an orientation for a dental mold with an occlusal (bite) surface 1000 facing in a first direction D1 and a gingival (gum) surface 1100, which meets the occlusal surface 1000 and is substantially parallel with the occlusal surface 1000, facing in a second direction D2 substantially opposite the first direction D1. The dental model 900 may comprise metadata distinguishing the occlusal surface 1000 and the gingival surface 1100, such that generating a mold (as discussed below) can automatically generate a parting surface based at least in part on the distinction between components of the dental model. It should be understood that certain dental models 900 may have other components distinguished using metadata. A resulting dental mold may have a parting line which is substantially parallel with the occlusal and gingival surfaces, and allows for two mold halves to part, or separate. In the example, one half of the injection mold parts and separates in a direction substantially the same as the direction D1 faced by the occlusal surface 1000 (a first parting direction), and the other half of the injection mold parts and separates in the substantially opposite direction D2, faced by the gingival surface 1100 (a second parting direction). In the example, a buccal (cheek) side 1002 and the lingual (tongue) side 1004 of the patient's dental model are substantially perpendicular to the occlusal surface and are therefore bisected by a proposed parting line.

Further, in the example, a patient's occlusal surface 1000 may extend a distance defined by a dental arch 1006 of the patient's dental model, or a curved structure that defines the patient's teeth. A patient's dental arch 1006 may generally separate a patient's buccal side 1002 from the lingual side 1004. A patient's dental arch 1006, in an example, spans the distance of the patient's occlusal surface 1000 and may represent a theoretical midplane between the patient's buccal side 1002 and lingual side 1004 of the patient's dental model.

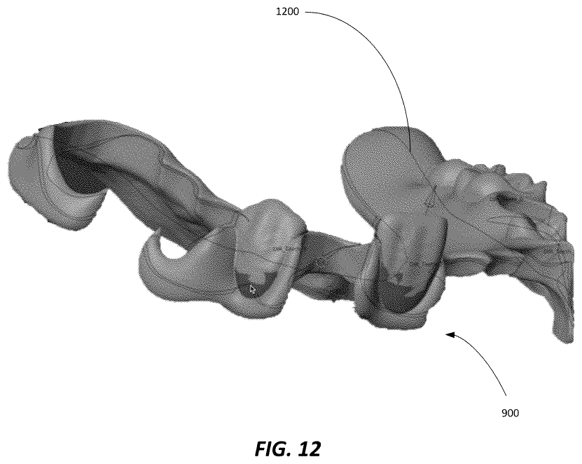

FIG. 12 illustrates a perspective view of a patient's dental model 900 with a parting line 1200 generated on the dental model 900. Referring back to FIG. 2, and with reference to FIGS. 10-12, in an example, a parting line 1200 may be generated using an algorithm which may identify the widest points of the patient's dental model 900 at a plurality of locations along the dental arch 1006. In an example, the parting line may be generated using an algorithm which may identify the point at which the occlusal surface 1000 (a patient's teeth) intersects with the gingival surface 1100 (the patients gum), for example, using metadata or geometical data within the model. In other words, the algorithm may identify points for a parting line at the gum line of the dental model. In an example, the parting line may be generated using an algorithm which takes into account both the widest points of the dental model along the dental arch, and points along the patient's gum line.

The widest points may be those points which extend the furthest in either the buccal 1002 or lingual 1004 direction from the midplane of the patient's dental arch 1006, on either or both buccal surface 1002 and lingual surface 1004. The algorithm thus may identify a plurality of points at which an injection mold may need to part or separate to avoid undercuts in a proposed mold design. The algorithm may further connect the plurality of points along the buccal and lingual surfaces to form a proposed parting line for an injection mold.

In an example, a parting line 1200 may be generated using an algorithm which may evaluate the geometry of dental model 900 and generate a closed loop (parting line 1200) around the outer surface of the dental model 900 which only focuses on minimizing undercut areas in either direction from the parting line 1200 on the surface of the dental model 900.

The method 200 may further include at block 208 manipulating a proposed parting line. In an example, a parting line generated by a parting line generation module may not be completely optimized for an injection mold for manufacturing dental appliances or prostheses. In an example, a parting line may be intentionally modified or manipulated to account for a slide to be later introduced to the proposed dental injection mold, or to account for a modification or manipulation to the patient's actual dental model and/or dentition. In an example, a mold design system may further include a parting line manipulation module (such as the parting line manipulation module 116 pictured in FIG. 1). The parting line manipulation module may enable a user to edit the proposed parting line by using a mouse, cursor, directional buttons, or similar aspect of a user device to drag, move, or otherwise edit a proposed parting line.

The method 200 may further include at block 210 generating a parting surface for an injection mold design. In an example, a parting surface generation module (such as the parting surface generation module in 118 FIG. 1) may generate a parting surface, or a parting plane, for the injection mold design. In the example, the parting surface generation module may use a second algorithm to identify the parting line generated by a parting line generation module (such as the parting line 1200 illustrated in FIG. 12). In another example, a second algorithm used by the parting surface generation module may be related to, or otherwise depend on, the first algorithm employed by the parting line generation module. In an example, the parting surface generation module, and specifically an algorithm executed by the parting surface generation module, may create a closed loop formed by connecting the open ends of the parting line which spans the distance of the patient's dental arch on both the buccal side and lingual side of the patient's dental arch.

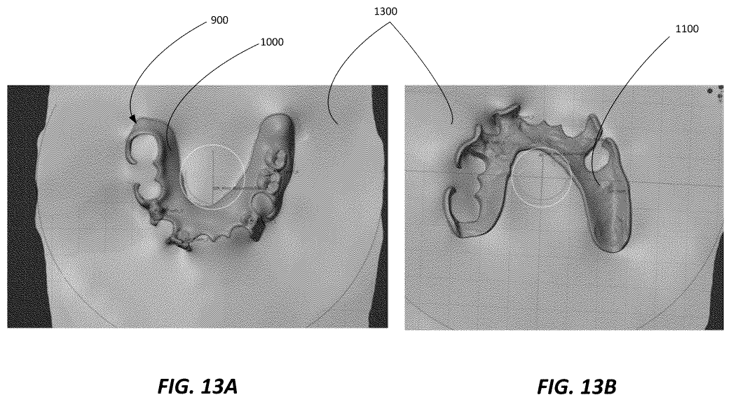

FIGS. 13A-B illustrate top and bottom views, respectively, of an example parting surface 1300 of a dental model 900. The parting surface generation module may create a surface 1300 using the closed loop of the parting lines as the perimeter of the surface. The parting surface generation module, specifically the algorithm executed by the parting surface generation module, may generate the surface such that the parting surface is confined by or bound to stay within the spatial limits of the patient's dental model 900. In other words, the parting surface 1300 may intersect or bisect the dental model 900 along a plane and separate the dental model 900 into two halves. In the example, a resulting injection mold may contain two halves which further have a mating and parting geometry that, when mated together, create a void in the shape of the patient's dental model, and may not further contain additional voids which may be representative of a parting surface that is not confined to the spatial limits of a patient's dental model. In another example, the parting surface generation module and the algorithm executed by the parting surface generation module may not generate a parting surface that is completely confined to the spatial limits of a patient's dental model.

Referring back to FIG. 2, the method 200 may further include, at block 212, manipulating a proposed parting surface. In an example, the parting surface generation module and the algorithm executed by the parting surface generation module may not generate a parting surface that is completely confined to the spatial limits of a patient's dental model. In the example, a mold design system may further include a parting surface manipulation module (such as the parting surface manipulation module 120 shown in FIG. 1). The parting surface manipulation module may enable a user to edit the proposed parting surface by using a mouse, cursor, directional buttons, or similar aspect of a user device to drag, displace, sculpt, move, or otherwise edit a proposed parting surface.

The method 200 may further include, at block 214, identifying potential undercuts. In an example, it may be difficult or not practical to manufacture an injection mold containing only two halves and which may eject an injection molded part without any undercuts. In the example, a mold design system may further include an undercut identification module (such as the undercut identification module 122 pictured in FIG. 1). The undercut identification module, in an example, may contain an algorithm which may evaluate a proposed injection mold geometry by evaluating the position of a proposed parting surface with respect to a patient's dental model, and identify undercuts specifically associated with denture geometries, including interproximal spaces, cervical margins, palatal vaults, and retromylohyoid undercuts in a resulting injection mold. Identified undercuts may be mapped to slide vectors aligned with the dental arch or gingival plane of a dental model to allow retrievability without compromising prosthetic fit to the patient.

With reference again to FIGS. 10 and 11, in an example, the undercut identification module may make a first measurement that is a measurement from the midplane of the patient's dental arch 1006 to either of the buccal surface 1002 or lingual surface 1004 of the patient's dental model 900 at a first depth, where the first depth may be at the parting surface identified by the parting surface generation module, or may be at a depth that is closer to the parting surface, or shallower in relationship to the parting surface than a second depth. Then, the undercut identification module may take a second measurement from the midplane of the patient's dental arch 1006 to either of the buccal surface 1002 or lingual surface 1004 of the patient's dental model at the second depth, where the second depth may at any distance along the parting direction of a proposed injection mold that is deeper than the first depth. If the second measurement is greater than the first measurement, in other words if the thickness of the void in a proposed injection mold is greater at any depth than the thickness at the parting surface, an undercut may occur when material fills the void in an injection molding process.

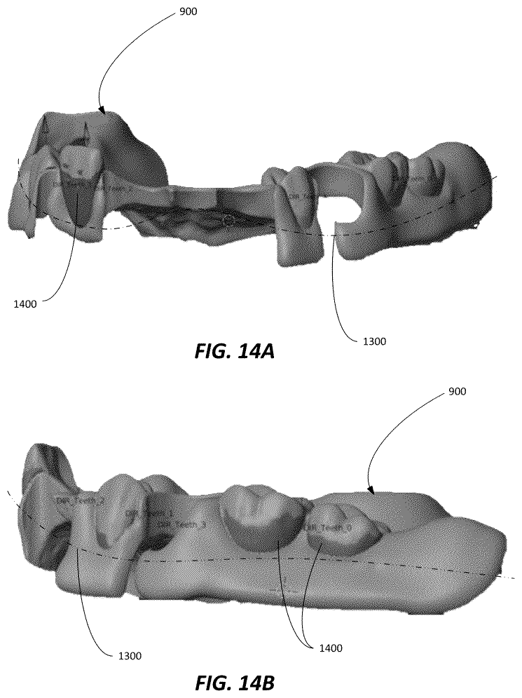

FIGS. 14A-B illustrate various views of an example output from block 214 of the method 200 illustrated in FIG. 2, identifying potential undercuts by undercut identification module. In FIGS. 14A-B, undercuts are identified as shaded regions 1400 on the dental model 900. In the example, the parting surface 1300 may divide the dental model 900 into an upper and lower portion for a proposed injection mold. In some areas, the dental model 900, were it to be material injected into a mold and then ejected in a direction normal to the proposed mold's surface (i.e. D1 or D2, illustrated in FIG. 11), would not be able to eject properly because of undercuts in the geometry. These areas may be highlighted by an undercut identification module (such as the undercut identification module 122 pictured in FIG. 1). As shown in FIGS. 14A and 14B, these areas may be identified as shaded areas 1400 on the dental model 900.

Referring back to FIG. 2, the method 200 may further include, at block 216, generating a proposed injection mold geometry. In an example, the mold design system, and specifically a mold generation module (such as the mold generation module 124 pictured in FIG. 1) may generate proposed mold geometry based on the generated parting surface and the patient's dental model.

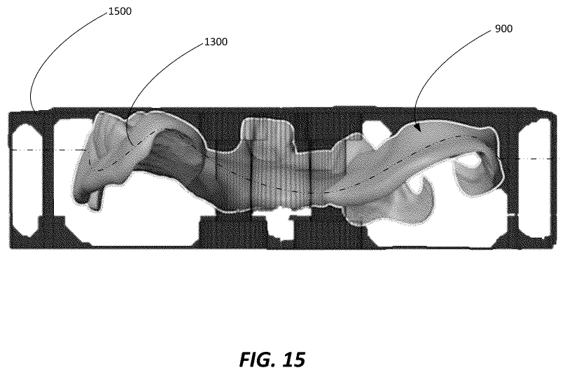

FIG. 15 illustrates an example mold generation step executed in block 216 of the example method 200 depicted in FIG. 2. In the example, the mold generation module may surround the patient's dental model 900 with a block of material, and in some examples a mold blank 1500 (virtually, in a 3D CAD environment). Then, the mold generation model may subtract the patient's dental model 900 from the block of material or mold blank 1500 using a Boolean operation to subtract the volume of the patient's dental model 900 from the block of material or mold blank 1500. The mold generation module may then divide the block of material or mold blank 1500 into two halves, a first injection mold side and a second injection mold side, using the parting surface 1300 generated by a parting surface generation module. In the example, an injection mold containing two halves to form a patient's dental model is modeled by the mold generation module.

Referring back to FIG. 2, the method 200 may further include, at block 218, generating slides for the proposed injection mold. In an example, it may be difficult or impractical to manufacture an injection mold with only two halves which does not contain any undercuts. In an example, the proposed injection mold geometry generated by the mold generation module may have at least one undercut area, which may cause difficulty when attempting to eject an injection molded part from an injection mold. In the example, the mold design system, and particularly a slide generation module (such as the slide generation module 126 pictured in FIG. 1) may further separate or segment the two halves of the injection mold geometry proposed by the mold generation module. In an example, the slide generation module may generate slides in response to the undercut identification module identifying undercuts in a proposed mold geometry.

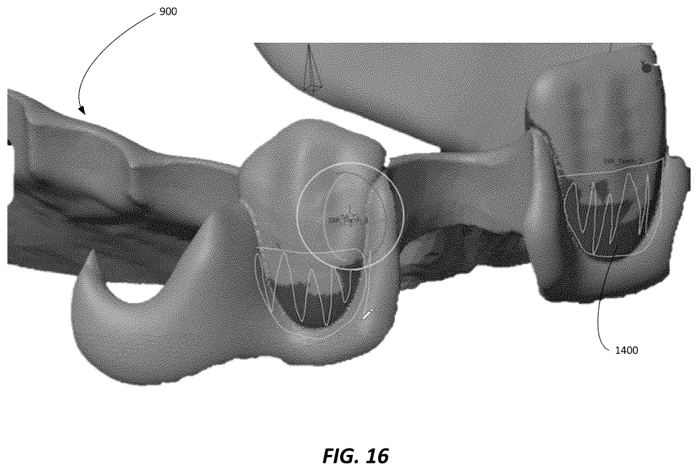

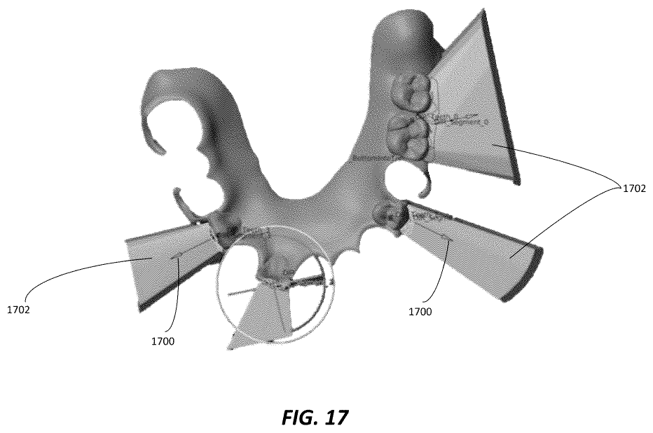

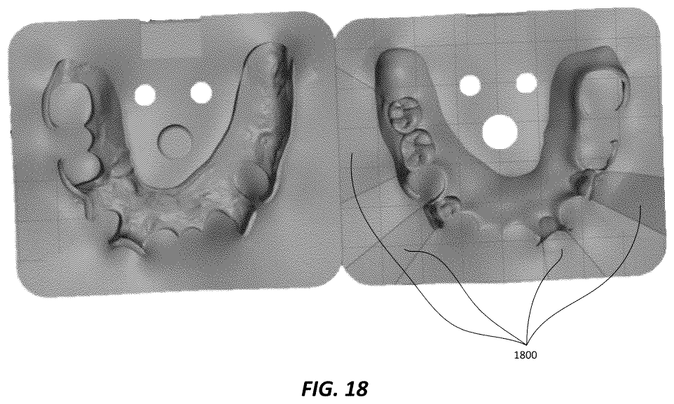

FIGS. 16-18 illustrate intermediate processes during and outputs of an example slide generation step executed in block 218 of the example method 200 depicted in FIG. 2. FIG. 16 illustrates areas on a dental model identified for slide generation, where the areas identified for slide generation correspond to the example output from block 214 illustrated in FIGS. 14A-B. FIG. 17 illustrates proposed slide geometry for a dental mold of the dental model from FIG. 16, the slide geometry corresponding to areas on a dental model identified for slide generation shown in FIG. 16. FIG. 18 shows a digital representation of a dental mold (including a first digital representation of a first mold component and a second digital representation of a second mold component) with slides (or digital representations thereof) removably positioned within the mold, the slides corresponding to the proposed slide geometry shown in FIG. 17.

Shown in FIG. 16, in the example, the slide generation module may identify areas of the proposed mold geometry corresponding to areas of the patient's dental model 900 identified by the undercut identification module, the shaded areas 1400. In an example, a user may manually identify areas for slide generation by selecting, with a mouse, pointer, or similar selection tool, areas on the dental model as shown in FIG. 16. In an example, the slide generation module may automatically, by machine learning or by a computer algorithm, identify areas of the proposed mold geometry corresponding to areas of the patient's dental model 900 identified by the undercut identification module, the shaded areas 1400.

Shown in FIG. 17, the slide generation module may identify a directional vector 1700 that is approximately normal to the undercut area 1400 of the patient's dental model. The slide generation module may then remove segments of the proposed mold geometry 1702 including the surface of mold geometry corresponding to the undercut area of the patient's dental model and may also remove any portion of the mold's wall that is in the directional vector approximately normal to the undercut area of the patient's dental model.

Shown in FIG. 18, in an example, the slide generation module may replace any removed portion 1702 of the mold's geometry with an insertable slide 1800 which replaces the geometry of the mold removed due to an undercut. In the example, the slide may be insertable into the mold geometry in an injection molding process, and after the injection molding process is complete, the slide may be slidably removed from the mold to allow for an injection molded component to be ejected from the injection mold geometry. In the example, the slide may be insertable into the mold geometry in an injection molding process, and after the injection molding process is complete, the slide may be slidably removed from the mold which may allow for insertion of prefabricated parts for injection over-molding. In the example, separate components of the dental appliance or dental prosthesis, such as teeth, may be premade and must be inserted prior to injection, and the teeth may also be ejected along with the injection molded part once unified with the final dental appliance geometry.

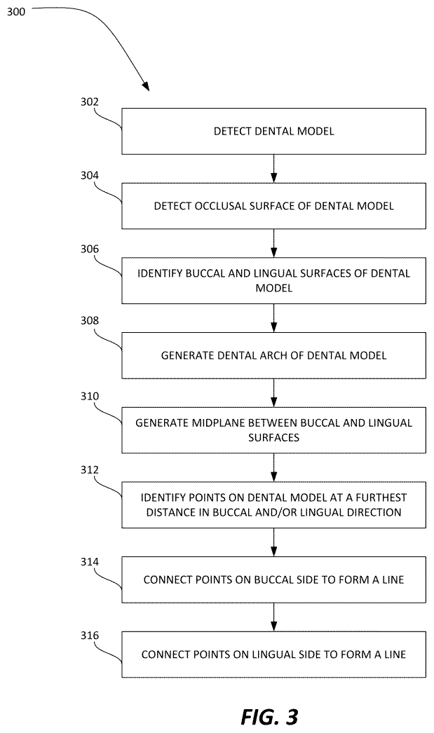

FIG. 3 is a flow chart illustrating an example method 300 of generating a parting line for a dental injection mold, in accordance with various embodiments. The method 300, or one or more portions of the method 300, may be performed by the system 100 illustrated in FIG. 1, and more particularly by the parting line generation module 114, in some embodiments. In some embodiments, the parting line generation module may execute an algorithm which is configured to perform one or more of the following portions of the method 300. The method 300 may include, at block 302, detecting a patient's dental model in a 3D CAD modeling environment. In an example, the parting line generation module may be configured to detect a patient's dental model based on common geometry, such as a dental arch, present in most or all dental models. In an example, a user may prompt the parting line generation module to detect an imported dental model from the dental model importer module 112 illustrated in FIG. 1.

The method 300 may further include, at block 304, detecting an occlusal or bite surface of the dental model. In an example, the parting line generation module may be configured to detect a patient's dental model based on geometry common to all dental models. In an example, a user may identify one or more reference points on a dental model of a patient, which may indicate to the parting line generation module reference points indicative of the occlusal or gingival surface of a dental model. In an example, the parting line generation module may reference the occlusal surface of the dental model to perform subsequent steps of the method 300, specifically in generating a parting line that is substantially parallel to the occlusal surface of the dental model.

The method 300 may further include, at block 306, identifying a buccal and lingual surface of the patient's dental model. In an example, the buccal (check) and lingual (tongue) surfaces of the dental model are substantially normal to the occlusal surface of the dental model. In an example, the buccal side may refer to the convex surface of the patient's dental model facing the patient's cheeks, while the lingual side may refer to the concave surface of the patient's dental model facing the patient's tongue. In an example, a user may identify one or more reference points on a dental model of a patient, which may indicate to the parting line generation module reference points indicative of the buccal and lingual surfaces of a dental model. In an example, the parting line generation module may reference the buccal and lingual surfaces of the dental model to perform subsequent steps of the method 300, specifically in generating a dental arch follows a path defined by the buccal and lingual surfaces.

The method 300 may further include, at block 308, generating a dental arch of a dental model. In an example, the parting line generation module may be configured to generate a patient's dental arch based on geometry common to all dental models. In an example, the parting line generation module may reference the buccal and lingual surfaces of a patient's dental model to generate a dental arch that bisects, runs parallel to, or otherwise corresponds to a path defined by the buccal and lingual sides of a patient's dental model. In an example, a user may identify one or more reference points on a dental model of a patient, which may indicate to the parting line generation module reference points indicative of the dental arch. In an example, the parting line generation module may reference the dental arch of the dental model to perform subsequent steps of the method 300, specifically in generating a midplane between the buccal and lingual side of the dental model that follows a path defined by the dental arch.

The method 300 may further include, at block 310, generating a midplane between the buccal and lingual surfaces of the dental model. In an example, the parting line generation module may generate a midplane that is between the buccal and lingual surface of the dental model, and further constrained within the spatial limits of the dental model. In an example, a user may identify one or more reference points on a dental model of a patient, which may indicate to the parting line generation module reference points indicative of the midplane. In an example, the parting line generation module may reference the midplane of the dental model to perform subsequent steps of the method 300, specifically in identifying points on the dental model at a furthest distance from the midplane in a buccal or lingual distance for a given position along the dental arch of the dental model.

The method 300 may further include, at block 312, identifying points on the dental model at a furthest distance from the midplane in a buccal or lingual distance for a given position along the dental arch of the dental model. In an example, the parting line generation module may execute an algorithm which, upon execution, identifies points on the dental model which are at a furthest distance extending in either the buccal or lingual direction from the midplane for a given position along the dental arch of the dental model. In an example, a user may further be able to identify points on the dental model which are at a furthest distance extending in either the buccal or lingual direction from the midplane for a given position along the dental arch of the dental model.

The method 300 may further include, at block 314, connecting the points on the buccal surface to form a line or a curve. In an example, the parting line generation module may execute an algorithm which, upon execution, may connect the points on the buccal surface of the dental model in a best-fit line or curve-fit method. In an example a user may be able to click and drag, move with directional arrows, or otherwise adjust the line generated by the parting line generation module. In an example the manipulation of the parting line may be performed by another functional module of the mold design system, particularly by the parting line manipulation module 116 illustrated in FIG. 1.

The method 300 may further include, at block 316, connecting the points on the lingual surface to form a line or a curve. In an example, the parting line generation module may execute an algorithm which, upon execution, may connect the points on the lingual surface of the dental model in a best-fit line or curve-fit method. In an example, a user may be able to click and drag, move with directional arrows, or otherwise adjust the line generated by the parting line generation module. In an example the manipulation of the parting line may be performed by another functional module of the mold design system, particularly by the parting line manipulation module 116 illustrated in FIG. 1.

In an example, the parting line generation module may connect the points on the lingual and buccal surface of the dental module simultaneously or may connect the points on the lingual surface and then the buccal surface. The order in which the points are connected on either of the buccal and/or lingual surface may be interchangeable. In an example, the parting line generation module may also connect the line generated on the buccal surface to the line generated on the lingual surface at both ends of each respective line, to form a closed loop around a perimeter of the dental model.

In another example, a parting line may be generated by a parting line generation module by first computing an initial parting direction by manually adjusting the anterior tilt of the dental model away from the occlusal surface. From this initial parting direction, a silhouette or shadow of the dental model may be computed and represented by a grid of cells in a 2-dimensional plane, projected in the direction of the initial parting direction. Any holes in the grouping of cells representing the silhouette or shadow may be filled in 2-dimensional space. The internal portion of the shadow of the dental model may be removed, leaving only the outline of the projected 2-dimensional shadow of the dental model. The outline of the dental model in the 2-dimensional grid space may then be back-projected onto the 3D dental model and refined and propagated along the 3D surface of the dental model until a smooth parting line is achieved. This results in a guaranteed separation into two regions. The process of back projecting may reduce the likelihood of undercut on either side of the parting surface.

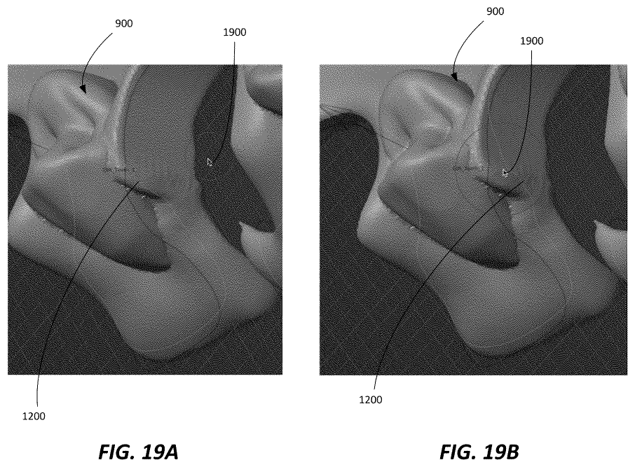

FIG. 12 illustrates a parting line 1200 generated on the dental model 900. FIGS. 19A-B illustrate a detail view of an example parting line 1200 generated on a patient's dental model 900, and an example operation of a parting line manipulation module, such as the parting line manipulation module 116 illustrated in FIG. 1. In an example, the parting line generated by a parting line generation module may need refinement. In an example, a cursor 1900 may be able to click and drag, move with directional arrows, or otherwise adjust the line 1200 generated by the parting line generation module, e.g., from the position shown in FIG. 19A to the position shown in FIG. 19B.

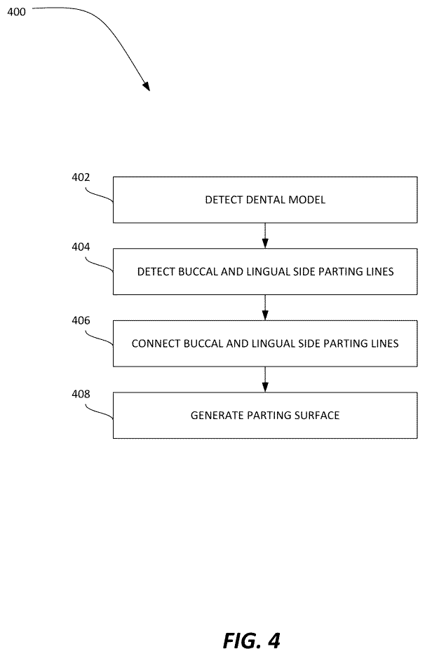

FIG. 4 is a flow chart illustrating an example method 400 of generating a parting surface for a dental injection mold, in accordance with various embodiments. The method 400, or one or more portions of the method 400, may be performed by the system 100 illustrated in FIG. 1, and more particularly by the parting surface generation module 118, in some embodiments. In some embodiments, the parting surface generation module may execute an algorithm which is configured to perform one or more of the following portions of the method 400. The method 400 may include, at block 402, detecting a patient's dental model in a 3D CAD modeling environment. In an example, the parting surface generation module may be configured to detect a patient's dental model based on common geometry, such as a dental arch, present in most or all dental models. In an example, a user may prompt the parting surface generation module to detect an imported dental model from the dental model importer module 112 illustrated in FIG. 1.

The method 400 may further include at block 404 detecting a buccal and lingual side parting lines. In an example, the parting surface generation module may detect or import the parting lines generated by the method 300 previously referenced and described above. In an example, a user may identify a parting line on a dental model using a parting line manipulation module, such as the parting line manipulation module 116 illustrated in FIG. 1.

The method 400 may further include, at block 406, connecting the buccal and lingual side parting lines. In an example, the parting surface generation module may connect the line generated on the buccal surface to the line generated on the lingual surface at both ends of each respective line to form a closed loop around a perimeter of the dental model.

The method 400 may further include, at block 408, generating a parting surface constrained within the volume of the dental model and bounded by the parting line perimeter. In an example, the parting surface generation model, specifically an algorithm executed by the parting surface generation module, may generate the surface such that the parting surface is confined by or bound to stay within the spatial limits of the patient's dental model. In the example, a resulting injection mold created from the parting surface may contain two halves which further have a mating and parting geometry defined by the parting surface that, when mated together, create a void in the shape of the patient's dental model, and may not further contain additional voids which may be representative of a parting surface that is not confined to the spatial limits of a patient's dental model.

In another example, the parting surface generation module and the algorithm executed by the parting surface generation module may not generate a parting surface that is completely confined to the spatial limits of a patient's dental model. In the example, a user may be able to click and drag, move with directional arrows, or otherwise adjust the surface generated by the parting surface generation module. In an example the manipulation of the parting surface may be performed by another functional module of the mold design system, particularly by the parting surface manipulation module 120 illustrated in FIG. 1.

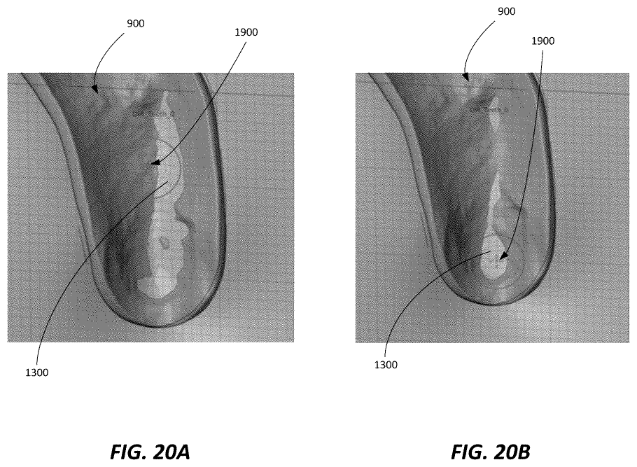

FIGS. 13A-B illustrate a parting surface 1300 generated on the dental model 900. FIGS. 20A-B illustrate a detail view of an example parting surface 1300 generated on a patient's dental model 900, and an example operation of a parting surface manipulation module, such as the parting surface manipulation module 120 illustrated in FIG. 1. In an example, the parting surface generated by a parting surface generation module may need refinement. In FIG. 20A, the parting surface is seen not completely intersecting the dental model 900, and instead leaves the spatial limits of the dental model and creates a void between the parting surface 1300 and the surface of the dental model 900. In an example, a cursor 1900 may be able to click and drag, move with directional arrows, or otherwise adjust the surface 1300 generated by the parting line generation module, e.g., from the position shown in FIG. 20A to the position shown in FIG. 20B.

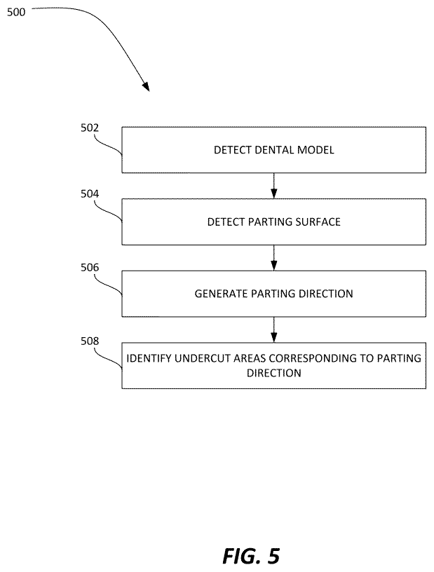

FIG. 5 is a flow chart illustrating an example method 500 of identifying undercut areas for a dental injection mold, in accordance with various embodiments. The method 500, or one or more portions of the method 500, may be performed by the system 100 illustrated in FIG. 1, and more particularly by the undercut identification module 122, in some embodiments. In some embodiments, the undercut identification module may execute an algorithm which is configured to perform one or more of the following portions of the method 500. The method 500 may include, at block 502, detecting a patient's dental model in a 3D CAD modeling environment. In an example, the undercut identification module may be configured to detect a patient's dental model based on common geometry, such as a dental arch, present in most or all dental models. In an example, a user may prompt the undercut identification module to detect an imported dental model from the dental model importer module 112 illustrated in FIG. 1.

The method may further include, at block 504, detecting a parting surface of the dental model. In an example, the undercut identification module may detect or import the parting surface generated by the method 400 previously referenced and described above. In an example, a user may identify a parting surface on a dental model using a parting surface manipulation module, such as the parting surface manipulation module 120 illustrated in FIG. 1.

The method may further include, at block 506, generating a parting direction. In an example, the undercut identification module may execute an algorithm which, when executed, generates a parting direction for an injection mold corresponding to, or substantially normal to the parting surface identified from block 504. In an example, a user may identify a parting direction manually within the undercut identification module.

The method may further include, at block 508, identifying undercut areas corresponding to the parting direction generated from block 506 and the dental model. In an example, the undercut identification module may execute an algorithm which identifies portions or areas of the dental model which, when fabricated within an injection mold, may not eject properly from an injection mold due to interference of the dental model as a fabricated part with other portions of the injection mold which are shaped to form other portions or areas of the dental model.

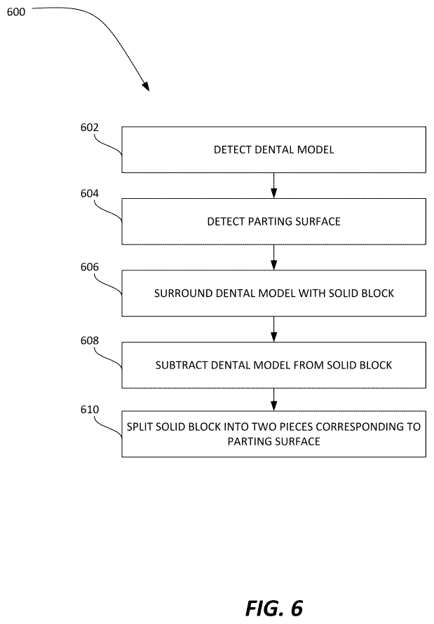

FIG. 6 is a flow chart illustrating an example method 600 of generating a dental injection mold, in accordance with various embodiments. The method 600, or one or more portions of the method 600, may be performed by the system 100 illustrated in FIG. 1, and more particularly by the mold generation module 124, in some embodiments. In some embodiments, the mold generation module may execute an algorithm which is configured to perform one or more of the following portions of the method 600. The method 600 may include, at block 602, detecting a patient's dental model in a 3D CAD modeling environment. In an example, the mold generation module may be configured to detect a patient's dental model based on common geometry, such as a dental arch, present in most or all dental models. In an example, a user may prompt the mold generation module to detect an imported dental model from the dental model importer module 112 illustrated in FIG. 1.

The method may further include, at block 604, detecting a parting surface of the dental model. In an example, the mold generation module may detect or import the parting surface generated by the method 400 previously referenced and described above. In an example, a user may identify a parting surface on a dental model using a parting surface manipulation module, such as the parting surface manipulation module 120 illustrated in FIG. 1.

The method may further include, at block 606, surrounding the dental model with a solid block in the 3D CAD modeling environment. In an example, the mold generation module may execute an algorithm which surrounds the dental model in a solid block of material (as represented in a 3D CAD program). In an example, the mold generation module and algorithm may additionally increase the size of the block of material to a distance which corresponds to a wall thickness of an injection mold, where the wall thickness may be determined by the size of the dental model, a proposed material to be used in an injection molding process, a designed pressure for the injection molding process, and/or other factors which may change a desired wall thickness of a resulting injection mold. In an example, a user may manually design in the 3D CAD environment a block of material to surround the dental model.

The method may further include, at block 608, subtracting the dental model from the solid block of material. In an example, the mold generation module may execute an algorithm which may subtract the dental model from the block of material using a Boolean operation in a 3D CAD environment. In an example, when the dental model is subtracted from the block of material, the block of material may contain a void that is substantially in the shape of the dental model which is to be manufactured by injection molding. In an example, the mold generation module may also increase or decrease the size of the void left in the block of material to account for an expansion or contraction of the injection molded part.

The method may further include, at block 610, splitting the block corresponding to a parting surface into two pieces. In an example, the mold generation module may reference the parting surface identified from block 604 to bisect the block of material into two halves, each half may be used as design for tooling an injection mold for a dental appliance or prosthesis. In an embodiment, a user may manually determine or adjust the parting surface and the splitting of the block into two halves. In an example, a user may identify a parting surface on the block of material using a parting surface manipulation module, such as the parting surface manipulation module 120 illustrated in FIG. 1.

Lastly, 3D CAD files of the resulting halves of the block of material is provided to a 3D printing device configured for converting a 3D CAD file into executable instructions for moving a 3D printing head to perform additive printing of an item having the geometrical features of the 3D CAD file. The additive printing my be performed using a material that, once cured, is flexible to create a flexible mold to facilitate ejection of delicate acrylic denture bases without fracture. In other embodiments, the additive printing may be performed using a material that, once cured, is rigid to create a rigid mold that has high dimensional accuracy for seating denture teeth during overmolding. The resulting mold (and slides, as discussed below) can be assembled by mating the two halves of the mold along the created parting surface. Once assembled, the mold material (e.g., acrylic) can be poured into the mold through sprues (discussed in greater detail herein) and cured to create the molded dental restoration (e.g., full denture or partial denture).

FIG. 7 is a flow chart illustrating an example method 700 of generating slides for a dental injection mold, in accordance with various embodiments. The method 700, or one or more portions of the method 700, may be performed by the system 100 illustrated in FIG. 1, and more particularly by the slide generation module 126, in some embodiments. In some embodiments, the slide generation module may execute an algorithm which is configured to perform one or more of the following portions of the method 700. The method 700 may include, at block 702, detecting a dental injection mold in a 3D CAD modeling environment. In an example, the slide generation module may be configured to detect a dental injection mold based on common geometry. In an example, a user may prompt the slide generation module to detect an imported dental injection mold from the dental model importer module 112 illustrated in FIG. 1. In an example, the slide generation module may import the dental injection mold generated from method 600 previously referenced and described above.

The method 700 may further include, at block 704, detecting undercut areas in an injection mold. In an example, the slide generation module may detect or import the undercut areas generated by the method 500 previously referenced and described above. In an example, a user may identify an undercut on a dental injection mold model, such as the injection mold generated from the method 600 previously referenced and described above.

The method 700 may further include, at block 706, generating a slide direction vector. In an example, the slide generation module may execute an algorithm which, when executed, generates a slide direction vector for a slide to be inserted and retracted from an injection mold which corresponds to, or substantially normal to the undercut area identified from block 704. In an example, a user may identify a slide direction vector manually within the slide generation module.

The method 700 may further include, at block 708, removing the undercut area from the injection mold. In an example, the slide generation module may execute an algorithm which extrudes with a subtraction Boolean operation the surface area of the dental injection mold corresponding to the undercut area and determined at block 704 along a path defined by the direction vector determined at block 706. In an example, a user may manually select areas on the injection mold corresponding to undercut areas and may manually set or adjust the direction vector which may be substantially normal to the undercut area.

The method 700 may further include, at block 710, replacing the removed undercut areas of the injection mold with a slide. In an example, the slide generation module may replace the subtracted-extruded material from the dental injection mold with a separate 3D modeled component. The separate component may contain substantially the same design of the dental injection mold corresponding to the undercut area removed at block 708, but which may be insertable and slidably removable from an injection mold, and function as a slide in an injection molding process.

As discussed in reference to method 600, the 3D CAD files of the slides may be provided to a 3D printer capable of converting the 3D CAD files into executable instructions for the 3D printer to perform additive printing to create the slides. The physical slides produced by the 3D printer can be assembled with the two halves of the mold (produced in accordance with method 600, for example) and used for manufacture of the molded dental prosthetic (e.g., full denture or partial denture).

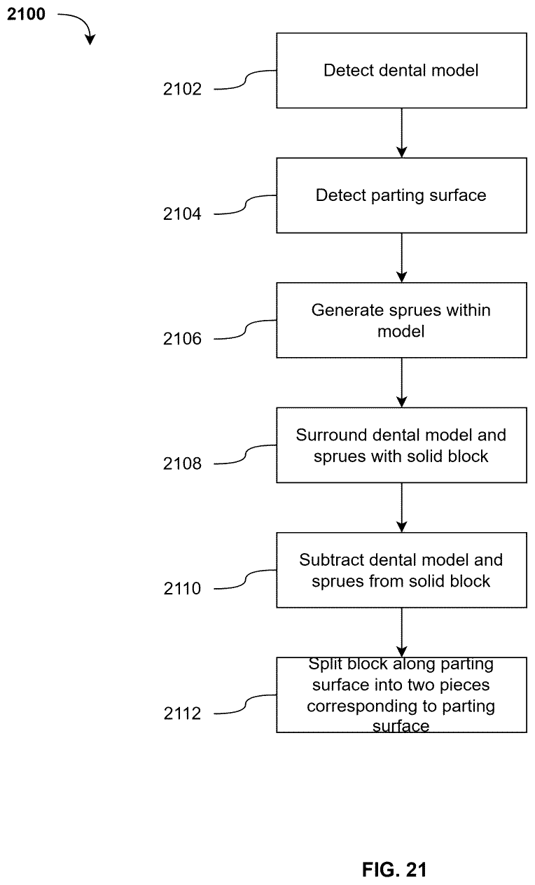

FIG. 21 is a flowchart depicting a method 2100 of generating sprues within 3D CAD models of injection molds and/or slides (if applicable). A sprue may be a channel or passage within an injection mold that allows molten material to flow from an external source into the mold cavity. In some aspects, a sprue may serve as an entry point for injected material, such as acrylic or other moldable substances, to reach the cavity where the dental prosthesis is formed. The sprue may extend from an outer surface of the mold to connect with the internal cavity space, providing a controlled pathway for material delivery during the injection molding process. In some cases, a plurality of sprues may be designed within a 3D CAD file of a mold, so that some of the sprues may be used for pouring molten material into the mold, and others of the plurality of sprues may act as vents to allow air to escape from the interior of the mold as molten material is poured therein, so the resulting molded dental prosthetic is free or substantially free of air bubbles.

In some cases, a sprue may be designed with specific dimensions to regulate the flow rate and pressure of the injected material. The sprue may also facilitate the removal of excess material after the molding process is complete. In dental injection molding applications, the sprue may be positioned to minimize interference with the final dental prosthesis while ensuring adequate material flow to completely fill the mold cavity. The sprue may be formed as an integral part of the mold design or may be created as a separate channel that connects to the main mold structure.

Moreover, the sprue may be formed entirely within one mold component (with an open side defined by the parting surface that is closed to define the channel when all of the mold components (having mating mold surfaces) are assembled. In other embodiments, the sprue may be defined partially within a plurality of mold components, on either side of a parting surface, so that each mold component has a sprue cavity defined within a parting surface thereof, and those sprue cavities align when the mold components are assembled. In some embodiments, a first sprue cavity may be defined in one mold component, and a second sprue cavity (that does not align with the first sprue cavity) is defined in a second mold component. Each of the first sprue cavity and second sprue cavity may define different ones of a plurality of sprues extending through the mold.

As shown in FIG. 21, the method 2100, or one or more portions of the method 2100, may be performed by the system 100 illustrated in FIG. 1, in some embodiments or more particularly by the mold generation module 124. In some embodiments, the system 100 may execute an algorithm which is configured to perform one or more of the following portions of the method 2100. The method 2100 may include, at block 2102, detecting a dental injection mold in a 3D CAD modeling environment, for example, by detecting a dental injection mold based on common geometry. In an example, a user may prompt the system 100 to detect an imported dental injection mold from the dental model importer module 112 illustrated in FIG. 1. In an example, the system 100 (e.g., the mold generation module 124) may import the dental injection mold generated from one or more methods previously referenced and described above.

The method may further include, at block 2104, detecting a parting surface of the dental model. In an example, the mold generation module may detect or import the parting surface generated by the methods previously referenced and described above. In an example, a user may identify a parting surface on a dental model using a parting surface manipulation module, such as the parting surface manipulation module 120 illustrated in FIG. 1. In use, sprues are filled with material that cure along with the molded dental prosthetic. Without proper placement, the material cured within the sprues can create interferences that would prevent removal of the cured dental prosthetic from the mold. So the mold generation module is configured to place the sprues along (intersecting) the parting surface of the mold so that the material within the sprues can be removed from an open side of the sprue exposed through the parting surface when the mold is disassembled after the molding process of the dental prosthetic is complete.

As shown at Block 2106, the model generation module generates one or more sprues within the model. Generation of the sprues ensures an uninterrupted flow path from a known location on the exterior of the mold (e.g., pouring ports). The model generation module is configured to automatically select one or more locations on the edge of the dental model, intersecting the parting surface for connecting the sprues with the dental model (the resulting cavity in the mold). The model generation module is configured to select the one or more locations for the sprues so that air can escape from the interior of the resulting mold that is generated according to the generated 3D model when molten material is poured through one or more of the sprues into the mold (e.g., by placing one or more of the sprues at the highest point in the formed cavity of the mold when oriented for pouring molten material through the sprues). The model generation module is further configured to automatically propose a size (e.g., diameter) and/or cross-sectional shape of the sprues and the points at which the sprues connect with the cavity of the mold. The cross-sectional size and shape of the sprues at the points at which the sprues connect with the cavity of the mold may be smaller than the remaining portion of the sprues, to facilitate removal (e.g., cutting or breaking) of the material cured within the sprues after removal of the molded part from the mold.

In some embodiments, the model generation module is configured to accept user input for manual placement of the sprues within the 3D CAD model of the mold. For example, a user may select a portion of the edge of the cavity/dental model (e.g., by clicking and/or dragging points along the edge of the dental model) for placement of the sprues. In some embodiments, the model generation module is configured to automatically place sprues within the 3D CAD model, and the model generation module is configured to accept user input moving the automatically placed sprues. FIG. 22 illustrates an example graphical user interface configured to receive user input identifying the location of sprues (or editing the location of sprues). As shown in FIG. 22, a dental model 2202 (e.g., having teeth and gums) is positioned within a solid block 2201 (e.g., a standardized size/shape of the solid block, having pouring ports 2210 on a side thereof). The user interface enables selection of portions of edges of the dental model 2202 (the selected portions shown in shaded portions, such as those labeled as 2203). The location and length of the selected portions of the edges of the dental model 2202 may be customized by the user, and/or the dental generation module may be configured to automatically select the location and length of the each selected portion along the edge of the dental model 2202. For the sake of clarity, the “length” of the selected portion is measured along, and follows the contours of the edge of the dental model 2202. In some embodiments, the location and length of the selected portions may be automatically identified as being aligned with the pouring ports 2210, such that sprues extending from the pouring ports 2210 to the selected portions of the edges of the dental model 2202 are at least substantially linear. The proposed location of sprues are shown in shaded portions, such as those labeled as 2204, with proposed center lines 2205 of the sprues.

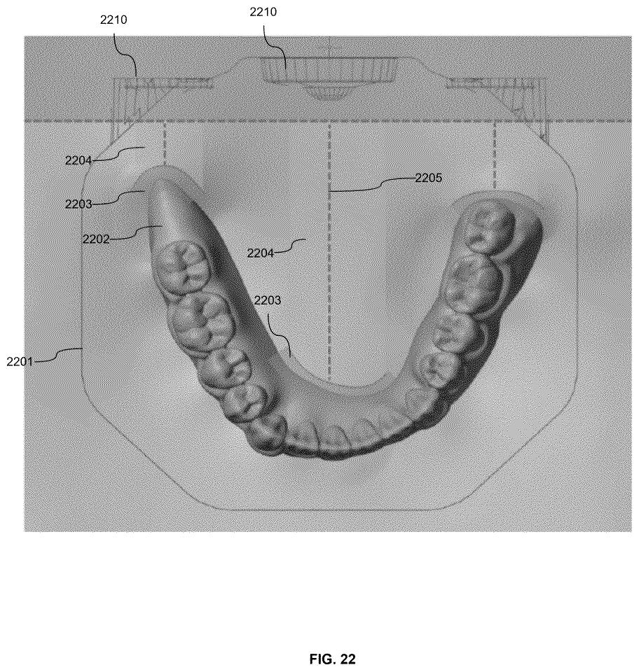

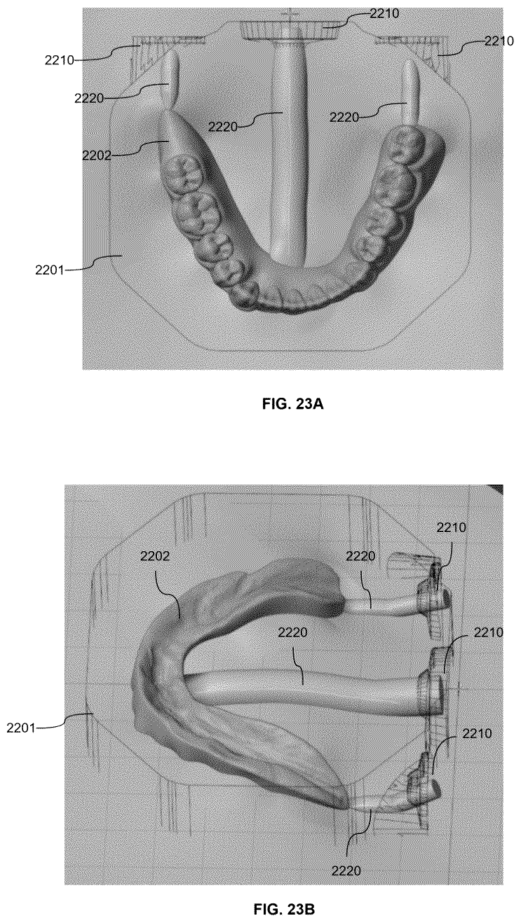

FIGS. 23A-23B illustrate perspective views of the example shown in FIG. 22, after the model generation module generates the sprues 2220 within the boundaries established using the graphical user interface of FIG. 22. Although the parting surface is not shown in FIGS. 23A-23B, it should be understand that the sprues are created to align/intersect the parting surface of the mold, so that the molded part and material cured within the sprues 2220 can be removed from the mold.

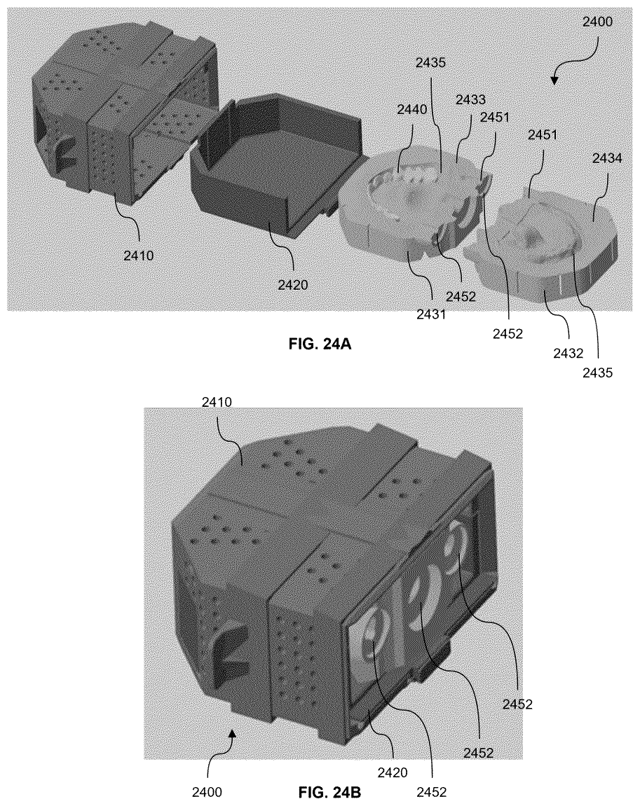

FIGS. 24A-24B illustrate a mold being assembled, after it has been designed (including after the parting surfaces and sprues have been established. The mold 2400 of FIGS. 24A-24B includes an outer housing 2410, a tray 2420, and two mold portions (bottom portion 2431 and top portion 2432). The bottom portion 2431 and top portion 2432 each have respective parting surfaces 2433, 2434 that mate together when assembled as shown in FIG. 24B. As shown, teeth 2440 are shown inserted into the mold 2400, so that molded gums (formed by pouring material and curing the material within the mold) are molded around the base of the teeth 2440. The bottom portion 2431 and top portion 2432 collectively form a cavity 2435 to be filled with molding material. Moreover, the mold 2400 defines sprues 2451 that extend from the cavity 2435 to pour ports 2452. The sprues are defined in part in the bottom portion 2431 and in part in the top portion 2432, such that the sprues 2451 intersect the parting surfaces 2433, 2434. These sprues 2451 are provided so that material can be poured through one or more of the pour ports 2452 when the mold 2400 is assembled as shown in FIG. 24B and into the cavity 2435 formed between the bottom portion 2431 and top portion 2432. After the molding material cures, the mold can be disassembled (similar to the configuration in FIG. 24A), and the molded part and material cured within the sprues 2451 can be extracted from the mold 2400. The material cured in the sprues 2451 can then be removed when finishing the molded part.

In some embodiments, the generated sprues may comprise a main trunk channel that aligns with a pouring port and a plurality of branch channels that extend from the main trunk channel to one or more locations on the 3D model (cavity) positioned along the gingival margin and intersecting the parting surface such that resin flows around the pre-positioned teeth bases (that are placed into the mold prior to adding uncured, molten resin material to the mold) and vents through palatal and posterior regions to provide more uniform flow of molten acrylic resin material into the cavity to fill in denture bases while minimizing flow artifacts on gingival surfaces visible in the final prosthesis. The main trunk channel may be positioned at a central location relative to the dental model to minimize flow distance variations and ensure balanced material distribution. The branch channels may be strategically positioned at different points along the perimeter of the dental model cavity, with each branch channel having a diameter that is optimized based on its distance from the main trunk channel and the local geometry of the dental model. In some embodiments, the branch channels may taper from a larger diameter at their connection to the main trunk channel to a smaller diameter at their connection to the dental model cavity, creating a controlled flow restriction that helps regulate material flow rate and pressure. The model generation module may automatically calculate the optimal number, positioning, and dimensions of branch channels based on the volume and geometry of the dental model cavity, the viscosity characteristics of the intended molding material, and the desired fill time for the injection molding process. In certain embodiments, the model generation module may be configured to accept manual user input adding, removing and/or manipulating certain of the automatically generated sprue channels. Additionally, the generated sprues may include overflow channels or vents positioned at strategic locations to allow trapped air to escape and excess material to flow out, preventing air bubbles and ensuring complete cavity filling.

As discussed in reference to method 600, the method may further include, at block 2108, surrounding the dental model and sprues with a solid block in the 3D CAD modeling environment, and subtracting the dental model and sprues from the solid block of material, as shown at 2110. In an example, the mold generation module may execute an algorithm which surrounds the dental model and sprues in a solid block of material (as represented in a 3D CAD program) and subtracts the dental model and sprues from the solid block of material to leave a void therein (as discussed in detail with respect to method 600) that is substantially in the shape of the dental model which is to be manufactured by injection molding with the sprues extending therefrom, to locations of standardized pouring port locations on the exterior of the solid block. In an example, the mold generation module and algorithm may additionally increase the size of the block of material to a distance which corresponds to a wall thickness of an injection mold, where the wall thickness may be determined by the size of the dental model, a proposed material to be used in an injection molding process, a designed pressure for the injection molding process, and/or other factors which may change a desired wall thickness of a resulting injection mold. In an example, a user may manually design in the 3D CAD environment a block of material to surround the dental model.

The resulting solid block may have one or more standardized features/characteristics, such as the location of pour ports that align with the generated sprues. In some embodiments, the model generation module stores and/or accesses a library of standardized features/characteristics for different mold designs. In some embodiments, the pour port locations and exterior dimensions of a mold may be selectable from a plurality of different library-standardized shapes/configurations. The model generation module is configured to extract a relevant one of the standardized mold configurations for alignment of the sprues with pour ports on an exterior of the mold.

The method may further include, at block 2112, splitting the block corresponding to a parting surface into two pieces. In an example, the mold generation module may reference the parting surface identified from block 2104 to bisect the block of material into two halves, each half may be used as design for tooling an injection mold for a dental appliance or prosthesis. In an embodiment, a user may manually determine or adjust the parting surface and the splitting of the block into two halves. In an example, a user may identify a parting surface on the block of material using a parting surface manipulation module, such as the parting surface manipulation module 120 illustrated in FIG. 1. As discussed above, the sprues intersect the parting surface, such that the mold generation module is configured to adjust the location, shape, and/or size of the sprues upon implementing changes to the configuration of the parting surface.

The method may further include using the mold formed in method 2100 to manufacture a dental prosthetic. In some embodiments, the two halves of the mold generated at block 2112 may be assembled together along the parting surface to form a complete mold assembly. The assembled mold may define an internal cavity that corresponds to the shape of the desired dental prosthetic, with the sprues providing access channels for material introduction and air evacuation.

In some cases, pre-manufactured prosthetic teeth may be positioned within the mold cavity before the molding material is introduced. The slides generated by the slide generation module may be inserted into their corresponding positions within the mold assembly to accommodate undercut areas and facilitate proper positioning of the prosthetic teeth (if relevant). The slides may be configured to hold the prosthetic teeth in their desired locations during the molding process.

The molding material, which may include acrylic resin or other suitable dental materials, may be introduced into the mold cavity through one or more pour ports defining an end of the sprues. In some embodiments, the molding material may be heated to a flowable state before introduction into the mold. The material may flow through the main trunk channel and branch channels of the sprue system to fill the cavity uniformly around the positioned prosthetic teeth, forming the gum portion of the dental prosthetic.

During the filling process, air within the mold cavity may escape through designated vent sprues, preventing the formation of air bubbles in the final prosthetic. The overflow channels may allow excess material to flow out, ensuring complete filling of the cavity while preventing overpressure within the mold.

After the molding material has been introduced and the cavity is filled, the material may be allowed to cure or solidify within the mold. The curing process may involve chemical cross-linking, cooling, or other solidification mechanisms depending on the specific molding material used. In some embodiments, the mold may be subjected to controlled temperature and pressure conditions to optimize the curing process.

Once the molding material has fully cured, the mold assembly may be disassembled by separating the two halves along the parting surface. The slides may be removed from their positions, allowing access to the undercut areas and facilitating removal of the completed dental prosthetic from the mold cavity. The cured material within the sprues may be separated from the dental prosthetic by cutting or breaking at the connection points where the sprues meet the prosthetic, after removal of the prosthetic (and material solidified in the sprues) from the mold.

The resulting dental prosthetic may include the pre-positioned prosthetic teeth securely embedded within the cured gum material, forming a complete denture or partial denture ready for finishing operations. In some cases, additional finishing steps may be performed to smooth surfaces, trim excess material, and prepare the prosthetic for patient fitting.

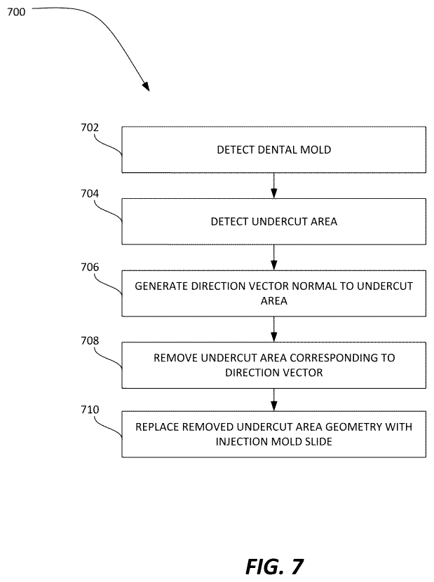

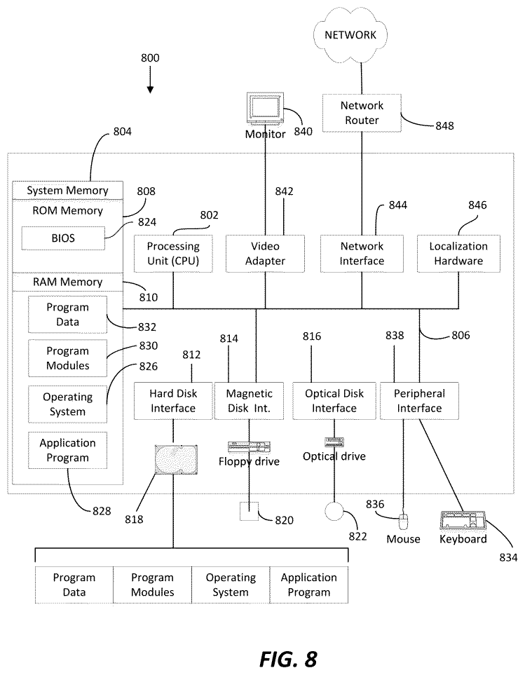

FIG. 8 is a diagrammatic view of an illustrative computing system that includes a computing system environment 800, such as a desktop computer, laptop, smartphone, tablet, or any other such device having the ability to execute instructions, such as those stored within a non-transient, computer-readable medium, in accordance with various embodiments. Furthermore, while described and illustrated in the context of a single computing system 800, those skilled in the art will also appreciate that the various tasks described hereinafter may be practiced in a distributed environment having multiple computing systems 800 linked via a local or wide-area network in which the executable instructions may be associated with and/or executed by one or more of multiple computing systems 800. The computing system environment 800, or one or more portions of the computing system environment 800, may comprise the computing device 10 and/or the mold design system 110 of FIG. 1, in some embodiments.

Computing system environment 800 may include at least one processing unit 802 and at least one memory 804, which may be linked via a bus 806. Depending on the exact configuration and type of computing system environment, memory 804 may be volatile (such as RAM 810), non-volatile (such as ROM 808, flash memory, etc.) or some combination of the two. Computing system environment 800 may have additional features and/or functionality. For example, computing system environment 800 may also include additional storage (removable and/or non-removable) including, but not limited to, magnetic or optical disks, tape drives and/or flash drives. Such additional memory devices may be made accessible to the computing system environment 800 by means of, for example, a hard disk drive interface 812, a magnetic disk drive interface 814, and/or an optical disk drive interface 816. As will be understood, these devices, which would be linked to the system bus 806, respectively, allow for reading from and writing to a hard disk 818, reading from or writing to a removable magnetic disk 820, and/or for reading from or writing to a removable optical disk 822, such as a CD/DVD ROM or other optical media. The drive interfaces and their associated computer-readable media allow for the nonvolatile storage of computer readable instructions, data structures, program modules and other data for the computing system environment 800. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 800.

A number of program modules may be stored in one or more of the memory/media devices. For example, a basic input/output system (BIOS) 824, containing the basic routines that help to transfer information between elements within the computing system environment 800, such as during start-up, may be stored in ROM 808. Similarly, RAM 810, hard drive 818, and/or peripheral memory devices may be used to store computer executable instructions comprising an operating system 826, one or more applications programs 828 (such as one or more applications that execute the methods and processes of this disclosure), other program modules 830, and/or program data 832. Still further, computer-executable instructions may be downloaded to the computing environment 800 as needed, for example, via a network connection.

An end-user may enter commands and information into the computing system environment 800 through input devices such as a keyboard 834 and/or a pointing device 836. While not illustrated, other input devices may include a microphone, a joystick, a game pad, a scanner, etc. These and other input devices would typically be connected to the processing unit 802 by means of a peripheral interface 838 which, in turn, would be coupled to bus 806. Input devices may be directly or indirectly connected to processor 802 via interfaces such as, for example, a parallel port, game port, firewire, or a universal serial bus (USB). To view information from the computing system environment 800, a monitor 840 or other type of display device may also be connected to bus 806 via an interface, such as via video adapter 842. In addition to the monitor 840, the computing system environment 800 may also include other peripheral output devices, not shown, such as speakers and printers.

The computing system environment 800 may also utilize logical connections to one or more computing system environments. Communications between the computing system environment 800 and the remote computing system environment may be exchanged via a further processing device, such a network router 848, that is responsible for network routing. Communications with the network router 848 may be performed via a network interface component 844. Thus, within such a networked environment, e.g., the Internet, World Wide Web, LAN, or other like type of wired or wireless network, it will be appreciated that program modules depicted relative to the computing system environment 800, or portions thereof, may be stored in the memory storage device(s) of the computing system environment 800.

The computing system environment 800 may also include localization hardware 846 for determining a location of the computing system environment 800. In embodiments, the localization hardware 846 may include, for example only, a GPS antenna, an RFID chip or reader, a WiFi antenna, or other computing hardware that may be used to capture or transmit signals that may be used to determine the location of the computing system environment 800.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various embodiments of the present invention.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

A number of implementations have been described. Nevertheless, it will be understood that various modifications may be made without departing from the spirit and scope of the disclosure. Accordingly, other implementations are within the scope of the following claims.

1. A method for generating a dental appliance injection model, the method comprising:
receiving a three-dimensional (3D) dental model representing a dental appliance;
detecting a parting direction of a mold of the dental model;
generating a parting line around a perimeter of the 3D dental model at least in part by detecting one or more of occlusal and gingival surfaces, gumline boundaries, and arch curvature using a first executable algorithm;
generating a parting surface for the dental model using a second executable algorithm; and
generating a first digital representation of a first mold component and a second digital representation of a second mold component and is aligned with the parting line; and wherein the first mold component and the second mold component define a mold cavity.

2. The method of claim 1, further comprising generating a slide component for insertion into at least one of the first mold component or the second mold component to change a shape of the mold cavity.

3. The method of claim 2, wherein generating the slide component comprises:
detecting in either of the first mold component or the second mold component, an undercut area; and
generating the slide component to form at least a portion of a shape of the undercut area within the mold cavity.

4. The method of claim 1, further comprising:
generating at least one sprue within at least one of the first mold component or the second mold component, wherein each of the at least one sprue intersects the parting surface and the mold cavity.

5. The method of claim 4, wherein generating the at least one sprue comprises generating a channel extending from the mold cavity to an exterior surface of the first mold component or the second mold component.

6. The method of claim 5, wherein the at least one sprue extends between a mold cavity and a pour port location at the exterior surface of the first mold component or the second mold component.

7. The method of claim 4, wherein the at least one sprue comprises a main trunk channel and a plurality of branch channels extending from the main trunk channel to different locations on the mold cavity.

8. The method of claim 4, wherein generating the at least one sprue comprises automatically selecting locations on an edge of the dental model that intersect the parting surface for connecting the at least one sprue with the mold cavity.

9. A system for generating a dental appliance injection model, the system comprising:
a processor; and
a memory storing instructions that, when executed by the processor, cause the processor to:
receive a three-dimensional (3D) dental model representing a dental appliance;
detect a parting direction of a mold of the dental model;
generate a parting line around a perimeter of the 3D dental model at least in part by detecting one or more of occlusal and gingival surfaces, gumline boundaries, and arch curvature using a first executable algorithm;
generate a parting surface for the dental model using a second executable algorithm; and
generate a first digital representation of a first mold component and a second digital representation of a second mold component and is aligned with the parting line; and wherein the first mold component and the second mold component define a mold cavity.

10. The system of claim 9, wherein the instructions further cause the processor to generate a slide component for insertion into at least one of the first mold component or the second mold component to change a shape of the mold cavity.

11. The system of claim 10, wherein generating the slide component comprises:
detecting in either of the first mold component or the second mold component, an undercut area; and
generating the slide component to form at least a portion of a shape of the undercut area within the mold cavity.

12. The system of claim 9, wherein the instructions further cause the processor to:
generate at least one sprue within at least one of the first mold component or the second mold component, wherein each of the at least one sprue intersects the parting surface and the mold cavity.

13. The system of claim 12, wherein generating the at least one sprue comprises generating a channel extending from the mold cavity to an exterior surface of the first mold component or the second mold component.

14. The system of claim 13, wherein the at least one sprue extends between a mold cavity and a pour port location at the exterior surface of the first mold component or the second mold component.

15. The system of claim 12, wherein the at least one sprue comprises a main trunk channel and a plurality of branch channels extending from the main trunk channel to different locations on the mold cavity.

16. The system of claim 12, wherein generating the at least one sprue comprises automatically selecting locations on an edge of the dental model that intersect the parting surface for connecting the at least one sprue with the mold cavity.

17. A non-transitory computer-readable medium storing instructions that, when executed by a processor, cause the processor to perform a method for generating a dental appliance injection model, the method comprising:
receiving a three-dimensional (3D) dental model representing a dental appliance;
detecting a parting direction of a mold of the dental model;
generating a parting line around a perimeter of the 3D dental model at least in part by detecting one or more of occlusal and gingival surfaces, gumline boundaries, and arch curvature using a first executable algorithm;
generating a parting surface for the dental model using a second executable algorithm; and
generating a first digital representation of a first mold component and a second digital representation of a second mold component and is aligned with the parting line; and wherein the first mold component and the second mold component define a mold cavity.

18. The non-transitory computer-readable medium of claim 17, wherein the method further comprises generating a slide component for insertion into at least one of the first mold component or the second mold component to change a shape of the mold cavity.

19. The non-transitory computer-readable medium of claim 18, wherein generating the slide component comprises:
detecting in either of the first mold component or the second mold component, an undercut area; and
generating the slide component to form at least a portion of a shape of the undercut area within the mold cavity.

20. The non-transitory computer-readable medium of claim 17, wherein the method further comprises:
generating at least one sprue within at least one of the first mold component or the second mold component, wherein each of the at least one sprue intersects the parting surface and the mold cavity.

21. The non-transitory computer-readable medium of claim 20, wherein generating the at least one sprue comprises generating a channel extending from the mold cavity to an exterior surface of the first mold component or the second mold component.

22. The non-transitory computer-readable medium of claim 21, wherein the at least one sprue extends between a mold cavity and a pour port location at the exterior surface of the first mold component or the second mold component.

23. The non-transitory computer-readable medium of claim 20, wherein the at least one sprue comprises a main trunk channel and a plurality of branch channels extending from the main trunk channel to different locations on the mold cavity.

24. The non-transitory computer-readable medium of claim 20, wherein generating the at least one sprue comprises automatically selecting locations on an edge of the dental model that intersect the parting surface for connecting the at least one sprue with the mold cavity.
